(19) United States
(12) Patent Application Publication
(10) Pub. No.: US 2026/0220941 A1
(43) Pub. Date: Jul. 30, 2026

(54) METHOD, APPARATUS, ELECTRONIC DEVICE, AND STORAGE MEDIUM FOR DISPLAYING A VIDEO EFFECT

(71) Applicant: Beijing Zitiao Network Technology Co., Ltd., Haidian District, Beijing (CN)

(72) Inventors: Shen Wu, Beijing (CN); Yunhao Liao, Beijing (CN)

(21) Appl. No.: 19/142,611

(22) PCT Filed: Dec. 11, 2023
(86) PCT No.: PCT/CN2023/137977

§ 371 Date: Jun. 23, 2025

(30) Foreign Application Priority Data
Dec. 23, 2022 (CN) 202211668451.3

(51) Int. Cl. G06V 20/40; G06V 40/16; G10L 15/22

(52) U.S. Cl. CPC G06V 20/46; G06V 40/165; G10L 15/22

(57) ABSTRACT

A method, an apparatus, an electronic device, and a storage medium for displaying a video effect are provided. A video is obtained, and a user speech is extracted from the video. At least one first word corresponding to a content of the user speech is generated according to the user speech in the video. A texture corresponding to the at least one first word is displayed on a word-by-word basis in the video. The texture moves outwards along a trajectory and around a region in the video as a center.

### CROSS-REFERENCE TO RELATED APPLICATION(S)

The present application claims priority to Chinese Patent Application No. 202211668451.3, filed on Dec. 23, 2022, and entitled “METHOD, APPARATUS, ELECTRONIC DEVICE, AND STORAGE MEDIUM FOR DISPLAYING A VIDEO EFFECT”, the entirety of which is incorporated herein by reference.

### FIELD

Embodiments of the present disclosure relate to the field of Internet, in particular to a method, an apparatus, an electronic device, and a storage medium for displaying a video effect.

### BACKGROUND

At present, various video applications (APPs) provide users with a function interface for user submissions, enabling users to capture and edit videos in the function interface, including adding a video effect to the video being captured.

In some related solutions, based on a specific effect prop selected by a user, a corresponding type of effect texture, such as a firework effect, a light effect, or the like, may be generated in the video, thereby enhancing visual expression of the video.

However, the video effect in the prior art cannot be associated with a user speech, resulting in issues such as poor visual effect, low interactivity, or the like.

### SUMMARY

The embodiments of the present disclosure provide a method, an apparatus, an electronic device, and a storage medium for displaying a video effect, to overcome the issues of poor visual effect and low interactivity.

According to a first aspect, an embodiment of the present disclosure provides a method of displaying a video effect, comprising:
obtaining a video, and extracting a user speech from the video; generating, according to the user speech in the video, at least one first word corresponding to a content of the user speech; and displaying, in the video, a texture corresponding to the at least one first word on a word-by-word basis, wherein the texture moves outwards along a trajectory and around a region in the video as a center.

According to a second aspect, an embodiment of the present disclosure provides an apparatus for displaying a video effect, comprising:
a speech module configured to obtain a video, and extract a user speech from the video;
a processing module configured to generate at least one first word corresponding to a content of the user speech according to the user speech in the video; and
a display module configured to display, in the video, a texture corresponding to the first word on a word-by-word basis, wherein the texture moves outwards along a trajectory and around a region in the video as a center.

According to a third aspect, an embodiment of the present disclosure provides an electronic device, comprising:
a processor, and a memory communicatively connected to the processor;
the memory storing computer-executable instructions;
the processor executing the computer-executable instructions stored in the memory, to implement the method of displaying a video effect according to the first aspect and various possible designs of the first aspect.

According to a fourth aspect, an embodiment of the present disclosure provides a computer-readable storage medium, where the computer-readable storage medium stores computer-executable instructions, and when the processor executes the computer-executable instruction, and the computer-executable instructions, when executed by a processor, implement the method of displaying a video effect according to the first aspect and the possible designs of the first aspect.

According to a fifth aspect, an embodiment of the present disclosure provides a computer program product, comprising a computer program, and the computer program, when executed by a processor, implements the method of displaying a video effect according to the first aspect and various possible designs of the first aspect.

### BRIEF DESCRIPTION OF DRAWINGS

In order to more clearly illustrate the embodiments of the present disclosure or the technical solutions in the prior art, the accompanying drawings used in the description of the embodiments or the prior art will be briefly introduced below, and it will be apparent that the drawings in the following description are some embodiments of the present disclosure, and those skilled in the art may also obtain other drawings according to these drawings without creative labor.

FIG. 1 is an application scenario diagram of a method of displaying a video effect according to an embodiment of the present disclosure;

FIG. 2 is a first schematic flowchart of the method of displaying a video effect according to an embodiment of the present disclosure;

FIG. 3 is a schematic diagram of a specific implementation process of step S102 in the embodiment shown in FIG. 2;

FIG. 4 is a schematic diagram of moving a texture in a video according to an embodiment of the present disclosure;

FIG. 5 is a schematic diagram of a specific implementation process of step S103 in the embodiment shown in FIG. 2;

FIG. 6 is a schematic diagram of moving another texture in a video according to an embodiment of the present disclosure;

FIG. 7 is a second schematic flowchart of the method of displaying a video effect according to an embodiment of the present disclosure;

FIG. 8 is a schematic diagram of a specific implementation process of step S203 in the embodiment shown in FIG. 7;

FIG. 9 is a schematic diagram of a region according to an embodiment of the present disclosure;

FIG. 10 is a schematic diagram of a specific implementation process of step S2032 in the embodiment shown in FIG. 8;

FIG. 11 is a schematic diagram of the distribution of moving start points according to an embodiment of the present disclosure;

FIG. 12 is a schematic diagram of a specific implementation process of step S204 in the embodiment shown in FIG. 7;

FIG. 13 is a schematic diagram of a deflection angle according to an embodiment of the present disclosure;

FIG. 14 is a schematic diagram of a specific implementation process of step S205 in the embodiment shown in FIG. 7;

FIG. 15 is a structural block diagram of an apparatus for displaying a video effect according to an embodiment of the present disclosure;

FIG. 16 is a schematic structural diagram of an electronic device according to an embodiment of the present disclosure; and

FIG. 17 is a schematic diagram of a hardware structure of an electronic device according to an embodiment of the present disclosure.

### DETAILED DESCRIPTION

In order to make the objectives, technical solutions and advantages of the embodiments of the present disclosure clearer, the technical solutions in the embodiments of the present disclosure will be clearly and completely described below with reference to the accompanying drawings in the embodiments of the present disclosure. It is apparent that the drawings in the following description are some embodiments of the present disclosure, rather than all of the embodiments. All other embodiments obtained by those skilled in the art based on the embodiments of the present disclosure without creative efforts shall fall within the scope of the present disclosure.

It should be noted that the user information (including but not limited to user equipment information, user personal information, or the like) and data (including but not limited to data for analysis, stored data, displayed data, or the like) involved in the present application are information and data that are authorized by the user or are sufficiently authorized by respective parties, and collection, use and processing of the related data needs to comply with relevant laws and regulations and standards of related countries and regions, and a corresponding operation portal is provided for the user to select for authorization or decline.

The following describes an application scenario of an embodiment of the present disclosure.

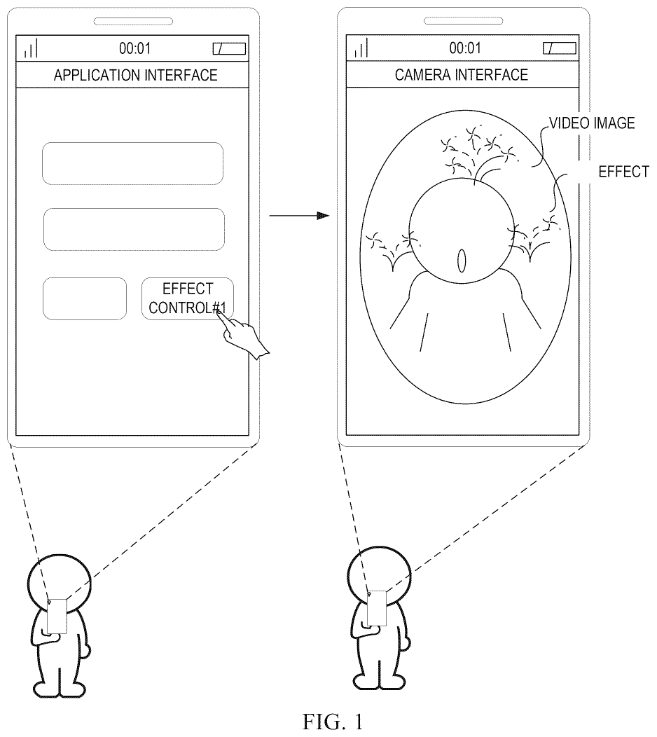

FIG. 1 is an application scenario diagram of a method of displaying a video effect according to an embodiment of the present disclosure. The method of displaying a video effect provided by the embodiment of the present disclosure may be applied to application scenarios such as video editing, video live streaming, or the like. Specifically, as shown in FIG. 1, the method provided in the embodiment of the present disclosure may be applied to a terminal device, for example, a smart phone, with a video application running in the terminal device. By triggering a video effect control or a function button (shown in the figure as “effect control #1”) in the video application within an application interface, the terminal device starts a camera interface to perform video capturing, performs real-time effect according to content in the captured video image, generates a corresponding effect in real time in the video image, and eventually generates an output video with a video effect. Then, the output video is stored in the server, and a user may save, forward, or share the output video with the video effect, thereby achieving video generation and posting.

In the prior art, based on the type of effect prop and control triggered by a user in an application, a corresponding type of effect texture, such as a firework effect, a light effect, or the like, may be generated in a video, thereby enhancing visual expression of the video. However, the video effect in the prior art is usually generated based on image information of the video, which cannot be associated with a user speech, resulting in issues of poor visual effect, low interactivity, or the like.

The embodiments of the present disclosure provide a method of displaying a video effect to solve the issues.

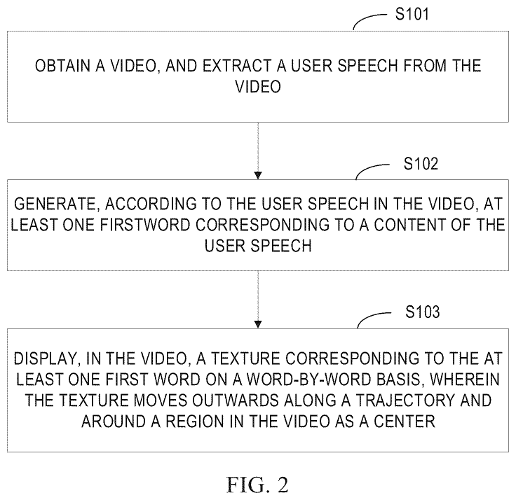

Referring to FIG. 2, FIG. 2 is a first schematic flowchart of the method of displaying a video effect according to an embodiment of the present disclosure. The method of the embodiment of the present disclosure may be applied to a terminal device, and the method of displaying a video effect comprises the following steps.

Step S101: a video is obtained, and a user speech is extracted from the video.

Step S102: at least one first word corresponding to a content of the user speech is generated according to the user speech in the video.

For example, referring to the application scenario diagram shown in FIG. 1, after the user triggers the effect control in the application by operating the terminal device, the camera interface is started to capture a video, thereby obtaining the video. In a possible case, the video may be a portrait video captured by a user, that is, a video containing a facial image of the user, where the user is a user that sends the user speech, and more specifically, for example, the content of the video is a “New Year greeting video”, briefly, that is, the user speaks out the lines of offering New Year greetings, the terminal device is aimed at the user for capturing a video, to obtain the video, and the user appears in the video, for example, as shown in FIG. 1. In another possible case, the video is a non-portrait video, that is, the camera unit of the terminal device is not aimed at the user for capturing, the user making the user speech does not appear in the video, and only the user speech made by the user is recorded. For the foregoing two possible cases, the video captured by the terminal device includes the user speech made by the user, then sound channel data is extracted from the video to obtain the user speech. Further, after the user speech is obtained, speech recognition is performed on the user speech to obtain the at least one first word corresponding to the content of the user speech.

It should be noted that, the video may be a part of a complete video captured by the terminal device, for example, in the application scenario shown in FIG. 1, after the terminal device starts the camera interface, video capturing (for example, lasts for 30 seconds) is performed, in this process, a video segment with a predetermined duration (for example, 1 second) obtained by the terminal device may be the video, and the terminal device processes the video segment (the video) with the predetermined duration to obtain the corresponding first word and displays an effect. Certainly, it may be understood that, in order to achieve a better speech recognition effect and semantic accuracy, in the process of generating the corresponding first word based on the user speech in the video, the first word may be generated by referring to the user speech corresponding to the one or more video segments in the videos on the basis of the user speech in the video, which will not be repeated here.

In a possible implementation, as shown in FIG. 3, a specific implementation of step S102 comprises the following steps.

Step S1021: speech recognition is performed on the user speech to obtain a corresponding speech text, and the speech text comprises at least one second word.

Step S1022: the second word in the speech text is detected, and in accordance with a determination that the second word is a predetermined first keyword, the second word is determined as the first word.

For example, after the user speech is extracted from the video, speech recognition is performed on the user speech to obtain the speech text corresponding to the speech content of the user speech, and a specific implementation of speech recognition is the prior art known to those skilled in the art, and details are not described herein. The speech text comprises one or more second words, and then the second word is detected. In accordance with a determination that the second word is the predetermined first keyword, the second word is extracted as the first word, and in accordance with a determination that the first keyword is not the first keyword, the process is omitted. Specifically, for example, after speech recognition is performed on the user speech, the obtained speech text is “I with you a happy cheerful new year”. Each Chinese character is a second word, that is, 8 second words in total. Then, the respective second word is further detected based on the first keyword, where the first keyword includes, for example, “Happy Cheerful New Year”, and therefore, 4 of the 8 second words “Happy Cheerful New Year” is determined as the first word. In the subsequent display of the first word, only the four Chinese characters “Happy Cheerful New Year” are displayed in the video, and the second words “I wish you a” are ignored and are not displayed.

In this embodiment, the speech text generated by the user speech is screened, and the keyword is extracted as the first word, thereby improving the information display efficiency of the text effect, reducing the display of words with useless and low information volume, reducing the display density of the word texture, and improving the display effect of the video effect.

Step S103: a texture corresponding to the at least one first word is displayed on a word-by-word basis in the video, where the texture moves outwards along a trajectory and around a region in the video as a center.

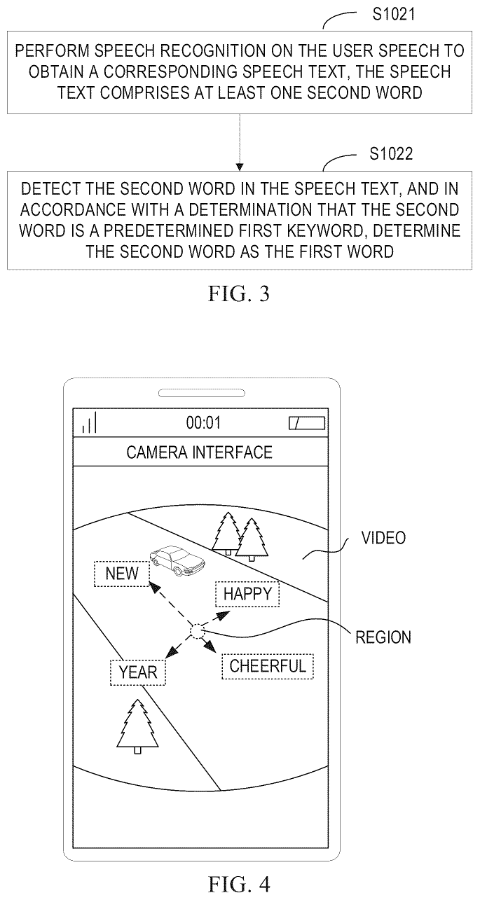

For example, after the terminal device obtaining the video through a camera unit, the video is played in real time, and the first word obtained in the previous step is synchronously converted into the corresponding texture and rendered into the video, to generate the effect of the video. The texture is rendered into the video on a word-by-word basis for display, and the process may be implemented by inputting the respective first word into a processing queue, and sequentially rendering the first word into the texture for display according to the processing queue, and the specific implementation process is not repeated herein. For each appeared texture, the texture is synchronously controlled to move from the region of the video to the outside of the region, to form a motion effect on the texture visually. FIG. 4 is a schematic diagram of moving a texture in a video according to an embodiment of the present disclosure. As shown in FIG. 4, in a possible implementation, the user who made the user speech does not appear in the video, that is, the video does not include the facial image of the user. In this case, the region is, for example, a circular region around the center of the video as an origin, and the texture corresponding to the first word appears from the region and moves around the outside of the region, and gradually approach the edge of the video. Specifically, referring to FIG. 4, the texture corresponding to the first word “new” moves to the upper left location in the video; the texture corresponding to the first word “year” moves to the lower left location in the video; the texture corresponding to the first word “happy” moves to the upper right location in the video; and the texture corresponding to the first word “cheerful” moves to the lower right location in the video. The texture moves along a path in the moving process. In a possible implementation, the path may be generated before the texture moves, for example, according to the generation location of the respective first word, a corresponding path is generated, and then the texture is controlled to move along the pre-generated path. Further, the path may be a straight path, that is, a path along a straight line towards the outside of the region; or may be a curved path, for example, a path around the region and curves towards the outside of the region, where the path may be randomly generated, or may be determined according to a predetermined function. In another possible implementation, the path is not determined before the texture moves, and is generated only after the texture starts to move. Further, in the video, the texture may be generated in the region and moves based on a corresponding moving direction, and the appearance location and the moving direction of the texture may be randomly generated, or determined according to a predetermined function, which is not limited herein.

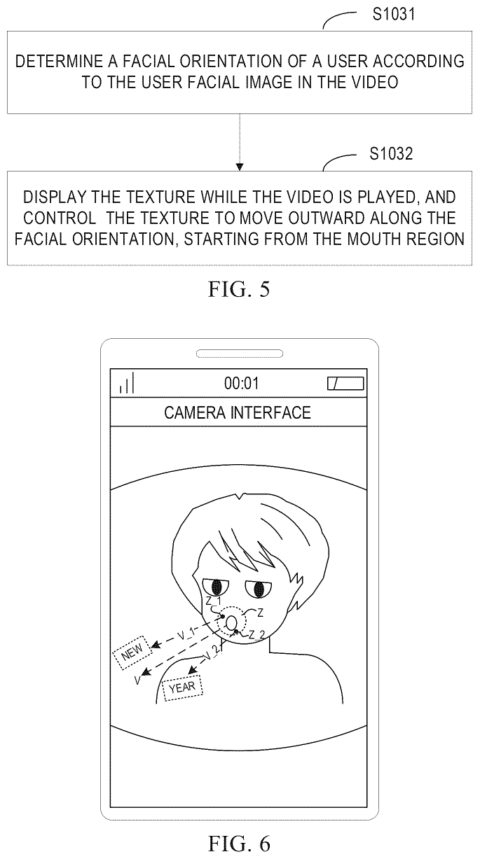

In another possible implementation, the video is a video comprising a user facial image, that is, a user who makes the user speech appears in the video. In this case, the region is a mouth region in the user facial image, and the region is determined after feature recognition is performed on the user facial image in the video, where the specific implementation is prior art and will not be repeated herein. That is, the texture corresponding to the first word moves around from the mouth region of the user in the video. Specifically, as shown in FIG. 5, a specific implementation of step S103 comprises the following steps.

Step S1031: a facial orientation of a user is determined according to the user facial image in the video.

Step S1032: the texture is displayed while the video is played, and the texture is controlled to move outward along the facial orientation, starting from the mouth region.

For example, the user facial image may be one or more video frames in the video, and by performing feature recognition and spatial mapping on the video frame of the video, a normal vector, that is, a facial orientation, of a plane of the space corresponding to the face of the user, in the three-dimensional space of a camera corresponding to the video, may be obtained. The specific implementation of obtaining the facial orientation of the character in the video based on the video is the prior art known to those skilled in the art, and details are not described herein again. Then, while the video is played, for example, the texture is controlled to move along the facial orientation, starting from any point in the mouth region, to achieve the movement of the texture. Alternatively, for each texture, a random offset angle is applied while moving along the facial orientation, so that the moving trajectories of the textures do not overlap, the display definition of the word is improved, and the visual effect is further improved. FIG. 6 is a schematic diagram of another texture moving in a video according to an embodiment of the present disclosure. As shown in FIG. 6, according to the user facial image in the video, a mouth region Z and a facial orientation V are determined. Then, for each texture, in the mouth region Z, a moving start point of the respective texture is randomly generated, and on the basis of the facial orientation V, an angle offset is randomly added to obtain a moving direction of the respective texture, and then the respective texture is controlled to move based on the moving start point and the moving direction. As shown in the figure, the first word “new” corresponds to the texture, the corresponding moving start point is Z_1, and the moving direction is V_1, where V_1=V+rand, rand is a random angle value within a predetermined range. Similarly, the first word “year” corresponds to the texture, the corresponding moving start point is Z_2, and the moving direction is V_2. Thus, outward movement of the texture is achieved.

In the steps of the embodiment, the moving start point and the moving direction of the texture are determined according to the mouth region, the facial orientation of a character in the video, and the content of the video, so that the movement of the texture matches the facial shape of the character in the video, a realistic visual effect of “a word jumping out from the mouth of a user” is formed, and the visual expression of the effect is improved.

In this embodiment, the video is obtained, and at least one first word corresponding to the content of the user speech is generated according to the user speech in the video; the video is played, and the texture corresponding to the first word is displayed on a word-by-word basis in the video, where the texture moves to the edge of the video and around the region in the video as a center. After the user speech in the video is converted into the corresponding first word, the texture corresponding to the first word is generated for display, so that the visual effect of the user speech is realized, while the texture is controlled to move outwards and around the region in the video as a center on a word-by-word basis for dynamic display, the visual display effect and the interactivity between the video effect and the video is improved.

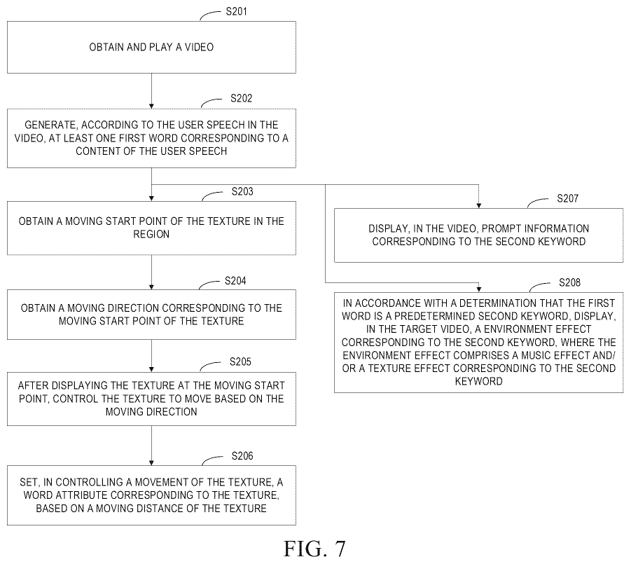

Referring to FIG. 7, FIG. 7 is a second schematic flowchart of the method of displaying a video effect according to an embodiment of the present disclosure. On the basis of the embodiment shown in FIG. 2, in this embodiment, step S102 is further refined, and the method of displaying a video effect comprises the following steps.

Step S201: a video is obtained and played.

Step S202: at least one first word corresponding to a content of the user speech is generated according to the user speech in the video.

Step S203: a moving start point of the texture is obtained in the region.

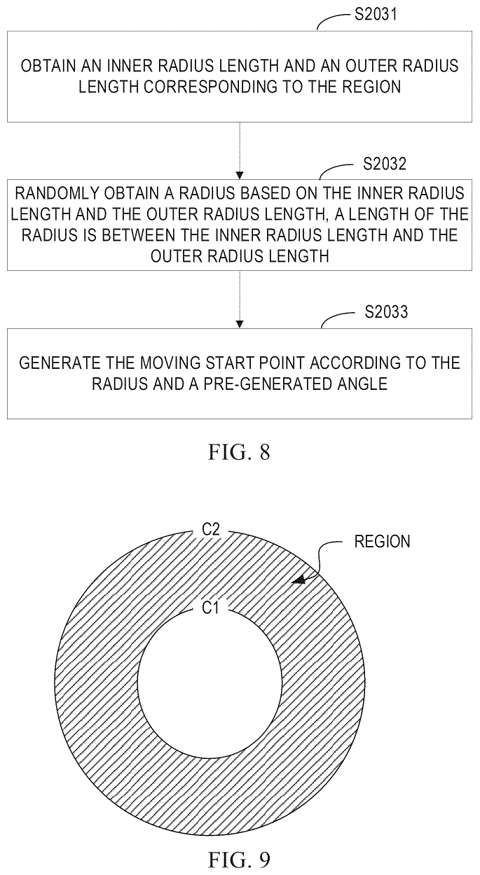

For example, in the region, the moving start point corresponding to the texture is randomly generated. In a possible implementation, as shown in FIG. 8, the region is annular region, and the specific implementation of step S203 comprises the following steps.

Step S2031: an inner radius length and an outer radius length corresponding to the region are obtained.

Step S2032: a radius is randomly obtained based on the inner radius length and the outer radius length, and a length of the radius is between the inner radius length and the outer radius length.

Step S2033: the moving start point is generated according to the radius and a pre-generated angle.

For example, FIG. 9 is a schematic diagram of the region according to an embodiment of the present disclosure, as shown in FIG. 9, the region is an annular region, and the region is enclosed by an inner circle C1 with a smaller radius and an outer circle C2 with a larger radius. The region between the inner circle C1 and the outer circle C2 is the region (annular region). In this embodiment, the video is a video comprising a user facial image, and the region may be determined based on the mouth region of the user in the user facial image. Specifically, for example, a center point corresponding to the mouth contour of the user is determined by performing image recognition on the user facial image in the video, and then the inner circle and the outer circle are determined based on the center point by using a predetermined first radius and a predetermined second radius, thereby the region is determined. The first radius is, for example, the inner radius length, and the second radius is, for example, the outer radius length.

After the region is determined, a radius is randomly determined in a length range formed by the inner radius length and the outer radius length of the region, for example, the inner radius length is 10 (with a predetermined unit, same below), the outer radius length is 20, and a formed radius length range is P1=(10, 20). Then, within the length range P1, the radius is randomly determined, for example, 12. Further, in a predetermined angle range (for example, 0 to 27), an angle is randomly generated as an angle, and then a unique point (that is, a moving start point) may be determined in the region according to the radius and the angle.

In this embodiment, the moving start point is determined by randomly determining the radius and the randomly generated angle in the annular region, where the radius is generated based on the annular region formed by the predetermined inner radius length and the outer radius length, thereby the control of the value range of the radius is achieved, and the radius is enabled to be within a reasonable range. Due to the limitation of the inner circle radius, the moving start point is not too close to the center point of the annular region (that is, the mouth region), so that the overlap of the texture in the moving process is reduced, and the visual effect of the word is improved.

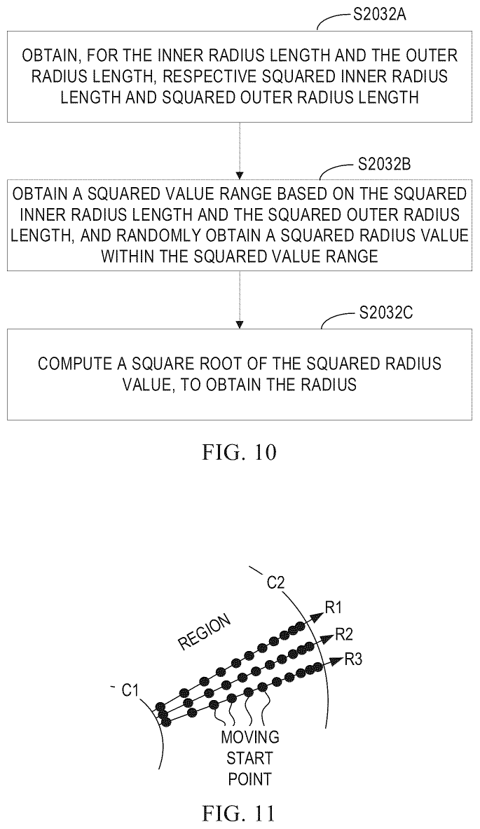

Further, in a possible implementation, as shown in FIG. 10, a specific implementation of step S2032 comprises the following steps.

Step S2032A: respective squared inner radius length and squared outer radius length are obtained for the inner radius length and the outer radius length.

Step S2032B: a squared value range is obtained based on the squared inner radius length and the squared outer radius length, and a squared radius value is randomly obtained within the squared value range.

Step S2032C: a square root of the squared radius value is computed, to obtain the radius For example, the inner radius length is 1, the outer radius length is 10, and after the inner radius length and the outer radius length are squared, the corresponding squared inner radius length is obtained as 1, and the squared outer radius length is obtained as 100. Then, in a squared value range P2=(1, 100), a value, that is, the squared radius value, is randomly obtained. After that, a square root operation is performed on the squared radius value for computing an arithmetic square root of the squared radius value, to obtain the radius. For example, if the squared radius value is 81, the corresponding radius is 9.

In the process of randomly selecting a point in a circular region in a manner of “radius +angle”, if value points in a value space corresponding to the radius are linearly distributed, the value points are denser at a location with a smaller radius, and more sparse at a location with a larger radius, resulting in unreasonable point distribution. In this embodiment, in the process of obtaining the radius randomly, however, the squared value range is obtained by the squared operation, then the squared radius value is randomly determined from the squared value range, and then an inverse square root operation is performed on the squared radius value, to obtain the radius that falls within the annular region. FIG. 11 is a schematic diagram of the distribution of moving start points according to an embodiment of the present disclosure, as shown in FIG. 11, in a process of randomly obtaining the moving start point for multiple times, taking a moving direction as R1 as an example, in the direction R1 in a region formed by an inner circle C1 and an outer circle C2, the distribution density of the moving start points is proportional to a squared radius, that is, the larger radius, the larger probability of occurrence of a moving start point, and the distribution rule of the moving start points is the same in a moving direction R2 and R3, and details are not described herein again. In the above manner, the randomly obtained radius is no longer a linear distribution, but points are more sparse at a location with a smaller radius, and points are denser at a location with a larger radius, so that the distribution of the moving start points in the region is more averaged, thereby presenting better rationality.

Step S204: a moving direction corresponding to the moving start point of the texture is obtained.

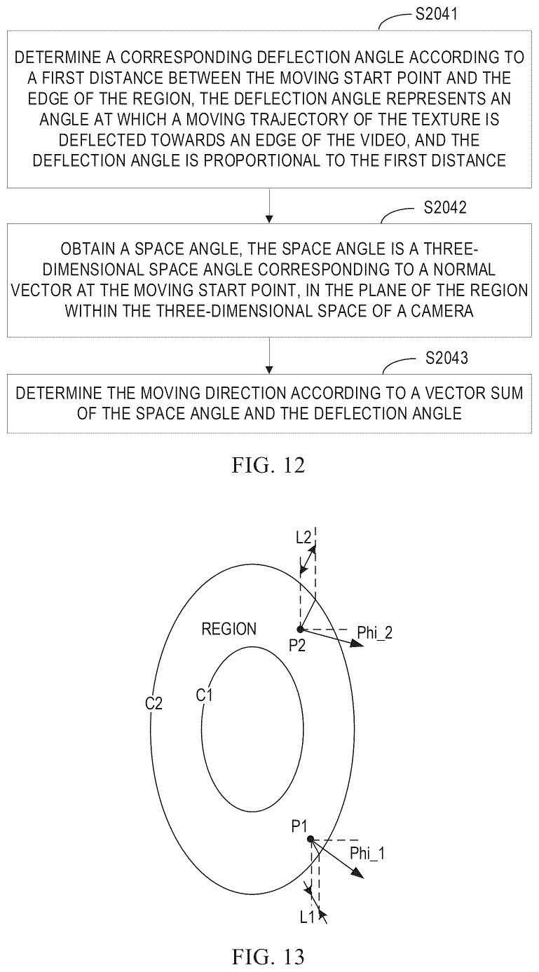

For example, the moving direction corresponding to the moving start point refers to a direction in which the texture starts to move at the moving start point, and the moving direction may be represented by a three-dimensional space vector. As shown in FIG. 12, a specific implementation of step S204 comprises the following steps.

Step S2041: a corresponding deflection angle is determined according to a first distance between the moving start point and the edge of the region. The deflection angle represents an angle at which a moving trajectory of the texture is deflected towards an edge of the video, and the deflection angle is proportional to the first distance.

Step S2042: a space angle is obtained, and the space angle is a three-dimensional space angle corresponding to a normal vector at the moving start point, in the plane of the region within the three-dimensional space of a camera.

Step S2043: the moving direction is determined according to a vector sum of the space angle and the deflection angle.

For example, after the moving start point is obtained, to make moving paths of the texture moving from different moving start points inconsistent, and to reduce the blocking between textures, the corresponding deflection angle, that is, the deflection angle, may be determined based on the first distance between the moving start point and the edge of the region, where the deflection angle represents an angle at which the moving trajectory of the texture is deflected towards the edge of the video, and the deflection angle corresponds to a predetermined value range, for example, [0, 15], that is, the deflection angle is between 0 degrees and 15 degrees. More specifically, the region is an annular region, and the larger the first distance from the moving start point to the outer edge of the region, the smaller the deflection angle; otherwise, the smaller the first distance from the moving start point to the outer edge of the region, the larger the deflection angle. FIG. 13 is a schematic diagram of a deflection angle provided by an embodiment of the present disclosure, as shown in FIG. 13, a distance from a moving start point P1 to an outer edge of the region is L1, and the deflection angle corresponding to the moving start point P1 is obtained as phi_1=10 according to a predetermined mapping relationship, that is, the deflection angle corresponding to the moving start point P1 is 10 degrees; a distance from a moving start point P2 to an outer edge of the region is L2, where L2 is greater than L1, the deflection angle corresponding to the moving start point P2 is obtained as phi_2=3 according to the predetermined mapping relationship, that is, the deflection angle corresponding to the moving start point P2 is 3 degrees. Certainly, it may be understood that the corresponding deflection angle may be determined by obtaining a second distance between the moving start point and an inner edge of the region, that is, the larger the second distance from the moving start point to the inner edge of the region, the larger the deflection angle; and the smaller the second distance between the moving start point and the inner edge of the region, the smaller the deflection angle. The specific implementation is similar to that shown in the foregoing embodiments, and details are not described herein again.

Then, the space angle corresponding to the moving start point is obtained, for example, the space angle represents the facial orientation or mouth orientation of the user in the video; in the case that the user in the video directly faces the camera, the space angle is, for example, 0 degrees; in the case that the facial orientation of the user in the video does not change relative to the capturing direction of the camera unit of the terminal device, the space angle is unchanged, that is, the space angles corresponding to the respective moving start points in the region are consistent. More specifically, the space angle is a three-dimensional space angle corresponding to the normal vector at the moving start point, in the plane of the region within the three-dimensional space of a camera, and the space angle may be obtained by analyzing the user facial image in the video. The specific implementation may be obtained from the relevant introduction of the steps of obtaining the user facial orientation in the embodiment shown in FIG. 2, and the details will not be repeated herein.

After that, a vector sum of the space angle and the deflection angle is computed to obtain the moving direction corresponding to the texture, and then the texture is controlled to move based on the moving direction obtained based on the vector sum of the space angle and the deflection angle, so that the moving direction of the texture and the orientation of the mouth and the face of the user may be consistent, improving the authenticity and the matching, and the probability that the moving trajectories of the respective textures are overlapped can be reduced, avoiding the mutual blocking between textures, thereby improving the visual performance of the effect and the display definition of word information.

Step S205: after the texture is displayed at the moving start point, the texture is controlled to move based on the moving direction.

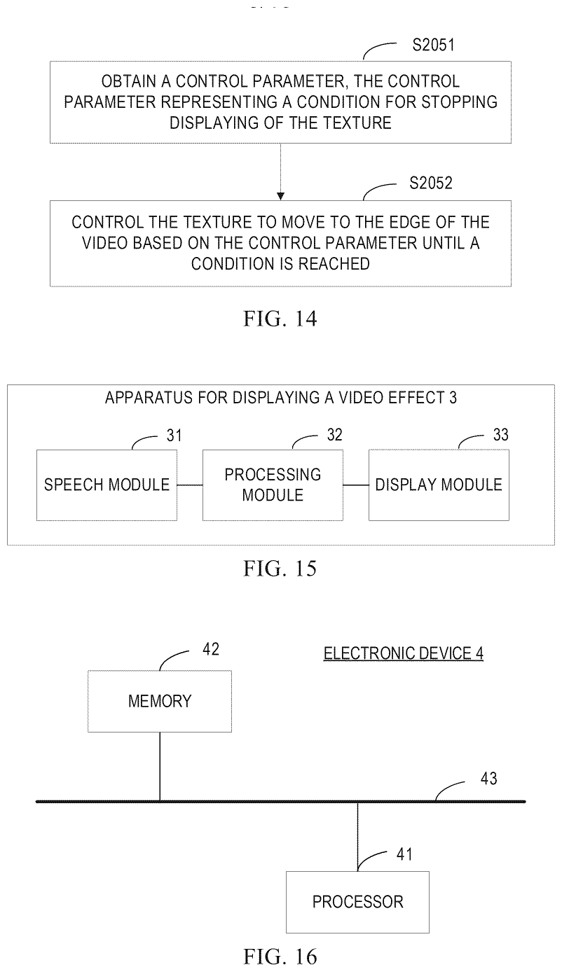

For example, as shown in FIG. 14, a specific implementation of step S205 comprises the following steps.

Step S2051: a control parameter is obtained, and the control parameter represents a condition for stopping displaying of the texture.

Step S2052: the texture is controlled to move to the edge of the video based on the control parameter until a condition is reached.

For example, after the moving start point and the corresponding moving direction are obtained, the appearance location and the moving direction of the texture may be determined according to the moving start point and the first direction, but an end location of the texture is still uncertain, therefore, the control parameter of the texture may be further obtained to determine the end location of the texture, that is, the condition for stopping displaying of the texture.

For example, the control parameter includes a moving duration and/or a moving distance; the moving duration represents a duration of a movement of the texture to the edge of the video; and the moving distance represents a continuous distance of the movement of the texture to the edge of the video. Specifically, for example, after the duration of movement of the texture towards the moving direction reaches 3 seconds (the moving duration), and/or after the distance of the texture towards the moving direction reaches 100 unit distances (the moving distance), the texture is stopped displaying, the texture disappears from the video, and the display of the texture for the first word ends.

Further, the moving duration and the moving distance in the control parameter may be a fixed predetermined value, or may be a random value obtained within a corresponding value range based on a predetermined value range of the moving duration and a value range of the moving distance, that is, a random moving duration and a random moving distance. As the moving duration and the moving distance change, there is a large probability that a moving speed (that is, the ratio of the moving distance and the moving duration) of the texture in the movement process changes accordingly, and therefore, by obtaining the random moving duration and the random moving distance, the texture corresponding to different first words may be displayed with different moving distances and speeds, achieving a randomized operating effect and enhancing the visual expression of the effect.

Step S206: a word attribute corresponding to the texture is set in controlling a movement of the texture, based on a moving distance of the texture.

Further, in the process of controlling the texture to move to the edge of the video, as the texture moves, the word attribute corresponding to the texture may be updated at the same time, so that the text shape of the texture representing the first word changes, for example, as the moving distance of the texture increases, the transparency gradually increases, the color gradually changes, or the like. Therefore, the visual expression of the word effect is further improved. For example, the word attribute includes at least one of the: font transparency, a font color, and a font size.

Alternatively, the method further comprises the following steps after step S201.

Step S207: prompt information corresponding to the second keyword is displayed in the video.

Step S208: in accordance with a determination that the first word is a predetermined second keyword, a environment effect corresponding to the second keyword is displayed in the video, where the environment effect comprises a music effect and/or a texture effect corresponding to the second keyword.

For example, in the process of playing the video, to further improve the interaction with the user, the prompt information may be displayed in a camera interface, thereby prompting a user to read out the second keyword corresponding to the prompt information, to guide the user to correctly use the video effect. Meanwhile, after the terminal device extracts the user speech according to the obtained video and performs recognition on the user speech to obtain the first word, the first word is compared with the second keyword. In accordance with a determination that the first word is consistent with the second keyword, it indicates that the second keyword indicated by the prompt information has read out by the user, and then a environment effect corresponding to the second keyword is played to further improve the visual performance. For example, the prompt information may include, for example, the text “please read aloud “Happy Cheerful New Year””. The second keyword is “Happy Cheerful New Year”. In accordance with a determination that the first word extracted from the video includes the second keyword “Happy Cheerful New Year”, the music corresponding to the second keyword “Happy Cheerful New Year” is played, and a texture effect, such as a firework effect, is displayed in the video. Therefore, interaction with the user is realized, enhancing the sense of participation of the user, and improving the visual expression of the effect.

In this embodiment, step S201 is consistent with step S101 in the above embodiment, and detailed discussion refers to the discussion of step S201, which will not be described herein again.

The embodiments of the present disclosure provide a method, an apparatus, an electronic device, and a storage medium for displaying a video effect. A video is obtained, and a user speech is extracted from the video; at least one first word corresponding to a content of the user speech is generated according to the user speech in the video. A texture corresponding to the at least one first word is displayed on a word-by-word basis in the video, where the texture moves outwards along a trajectory and around a region in the video as a center. By converting the user speech in the video into the corresponding first word, and generating the texture corresponding to the first word for display, a visual effect of the user speech is realized. By controlling the texture to move outwards along the trajectory and around the region in the video as the center on a word-by-word basis for dynamic display, the visual display effect and the interactivity between the video effect and the video is improved.

Corresponding to the method of displaying a video effect in the foregoing embodiments, FIG. 15 is a structural block diagram of an apparatus for displaying a video effect according to an embodiment of the present disclosure. For ease of illustration, only portions related to the embodiments of the present disclosure are shown. Referring to FIG. 15, the apparatus for displaying a video effect 3 comprises:
a speech module 31 configured to obtain a video, and extract a user speech from the video;
a processing module 32 configured to generate at least one first word corresponding to a content of the user speech according to the user speech in the video; and
a display module 33 configured to display, in the video, a texture corresponding to the first word on a word-by-word basis, wherein the texture moves outwards along a trajectory and around a region in the video as a center.

In an embodiment of the present disclosure, the video is a video comprising a user facial image, the region is a mouth region in the user facial image, and the display module 33 is configured to display, in the video, the texture corresponding to the first word on the word-by-word basis, which is specifically configured to determine a facial orientation of a user according to the user facial image in the video; and control the texture to move along the facial orientation, starting from the mouth region.

In an embodiment of the present disclosure, the processing module 32 is configured to generate, according to the user speech in the video, the at least one first word corresponding to the content of the user speech, which is specifically configured to perform speech recognition on the user speech to obtain a corresponding speech text, the speech text comprising at least one second word; and detect the second word in the speech text, and in accordance with a determination that the second word is a predetermined first keyword, determining the second word as the first word.

In an embodiment of the present disclosure, the display module 33 is further configured to, in accordance with a determination that the first word is a predetermined second keyword, display, in the video, an environment effect corresponding to the second keyword, where the environment effect comprises a music effect and/or a texture effect corresponding to the second keyword; and the display module 33 is further configured to, before displaying, in the video, the environment effect corresponding to the second keyword, display, in the video, prompt information corresponding to the second keyword.

In an embodiment of the present disclosure, the display module 33 is configured to display, in the video, the texture corresponding to the first word on the word-by-word basis, which is specifically configured to obtain a moving start point and a corresponding moving direction of the texture in the region; and after displaying the texture at the moving start point, control the texture to move based on the moving direction.

In an embodiment of the present disclosure, the display module 33 is configured to obtain the moving start point and the corresponding moving direction of the texture in the region, which is specifically configured to randomly generate, in the region, the moving start point corresponding to the texture; and obtain the moving direction according to a distance between the moving start point and an edge of the region, where the moving direction represents an angle between a moving path of the texture and a plane of the region, within a predetermined three-dimensional space of a camera.

In an embodiment of the present disclosure, the region is an annular region, and the display module 33 is configured to randomly generate, in the region, the moving start point corresponding to the texture, which is specifically configured to obtain an inner radius length and an outer radius length corresponding to the region; randomly obtain a radius based on the inner radius length and the outer radius length, a length of the radius being between the inner radius length and the outer radius length; and generate the moving start point according to the radius and a pre-generated angle.

In an embodiment of the present disclosure, the display module 33 is configured to randomly obtain the radius based on the inner radius length and the outer radius length, which is specifically configured to obtain, for the inner radius length and the outer radius length, respective squared inner radius length and squared outer radius length; obtain a squared value range based on the squared inner radius length and the squared outer radius length, and randomly obtaining a squared radius value within the squared value range; and obtain the radius according to a result of a square root operation on the squared radius value.

In an embodiment of the present disclosure, the display module 33 is configured to obtain the moving direction according to the distance between the moving start point and the edge of the region, which is specifically configured to determine a corresponding deflection angle according to a first distance between the moving start point and the edge of the region, the deflection angle representing an angle at which a moving trajectory of the texture is deflected towards an edge of the video, and the deflection angle being proportional to the first distance; obtain a space angle, the space angle being a three-dimensional space angle corresponding to a normal vector at the moving start point, in the plane of the region within the three-dimensional space of a camera; and determine the moving direction according to a vector sum of the space angle and the deflection angle.

In an embodiment of the present disclosure, the display module 33 is further configured to set, in controlling a movement of the texture, a word attribute corresponding to the texture, based on a moving distance of the texture; wherein the word attribute includes at least one of: font transparency, a font color, or a font size.

In an embodiment of the present disclosure, the display module 33 is configured to obtain a control parameter, the control parameter representing a condition for stopping displaying of the texture, which is specifically configure to control the texture to move based on the control parameter; wherein the control parameter includes a moving duration and/or a moving distance; the moving duration represents a duration of a movement of the texture; and the moving distance represents a continuous distance of the movement of the texture.

The speech module 31, the processing module 32, and the display module 33 are connected. The apparatus for displaying a video effect 3 provided in this embodiment may perform the solutions of the foregoing method embodiments, and implementation principles and technical effects thereof are similar, and details are not described herein again in this embodiment.

FIG. 16 is a schematic structural diagram of an electronic device according to an embodiment of the present disclosure. As shown in FIG. 16, the electronic device comprises:
a processor 41, and a memory 42 communicatively connected to a processor 41;
the memory 42 storing computer-executable instructions;
the processor 41 executing the computer-executable instruction stored in the memory 42 to implement the method of displaying a video effect in the embodiments shown in FIG. 2 to FIG. 14.

Alternatively, the processor 41 and the memory 42 are connected by a bus 43.

Related descriptions may be understood with reference to related descriptions and effects corresponding to the steps in the embodiments corresponding to FIG. 2 to FIG. 14, and details are not described herein again.

An embodiment of the present disclosure provides a computer-readable storage medium, where the computer-readable storage medium stores computer-executable instructions, the computer-executable instructions, when executed by a processor, implement the method of displaying a video effect provided in any of the embodiments corresponding to FIG. 2 to FIG. 14 of the present application.

FIG. 17 shows a schematic structural diagram of an electronic device 900 suitable for implementing embodiments of the present disclosure, and the electronic device 900 may be a terminal device or a server. The terminal device may include, but is not limited to, a mobile terminal such as a mobile phone, a notebook computer, a digital broadcast receiver, a personal digital assistant (PDA), a portable android device (PAD), a portable media player (PMP), an in-vehicle terminal (for example, an in-vehicle navigation terminal), and a fixed terminal such as a digital TV, a desktop computer, or the like. The electronic device shown in FIG. 17 is merely an example, and should not impose any limitation on the functions and scope of use of the embodiments of the present disclosure.

As shown in FIG. 17, the electronic device 900 may include a processing device (for example, a central processing unit, a graphics processing unit, or the like) 901, which may perform various appropriate actions and processing according to a program stored in a read only memory (ROM) 902 or a program loaded into a random access memory (RAM) 903 from a storage device 908. In the RAM 903, various programs and data required by the operation of the electronic device 900 are also stored. The processing device 901, the ROM 902, and the RAM 903 are connected to each other through a bus 904. An input/output (I/O) interface 905 is also connected to the bus 904.

Generally, the following devices may be connected to the I/O interface 905: an input device 906 including, for example, a touch screen, a touch pad, a keyboard, a mouse, a camera, a microphone, an accelerometer, a gyroscope, or the like; an output device 907 including, for example, a liquid crystal display (LCD), a speaker, a vibrator, or the like; a storage device 908 including, for example, a magnetic tape, a hard disk, or the like; and a communication device 909. The communication device 909 may allow the electronic device 900 to communicate wirelessly or wired with other devices to exchange data. While FIG. 17 shows an electronic device 900 having various devices, it should be understood that it is not required to implement or have all illustrated devices. More or fewer devices may alternatively be implemented or provided.

In particular, according to an embodiment of the present disclosure, the processes described above with reference to the flowchart may be implemented as a computer software program. For example, the embodiments of the present disclosure include a computer program product comprising a computer program carried on a computer-readable medium. The computer program comprises program code for performing the method shown in the flowchart. In such embodiments, the computer program may be downloaded and installed from the network through the communication device 909, or installed from the storage device 908, or from the ROM 902. When the computer program is executed by the processing apparatus 901, the foregoing functions defined in the method of the embodiments of the present disclosure are performed.

It should be noted that the computer-readable medium described above may be a computer-readable signal medium, a computer-readable storage medium, or any combination thereof. The computer-readable storage medium may be, for example, but not limited to, an electrical, magnetic, optical, electromagnetic, infrared, or semiconductor system, apparatus, device, or any combination thereof. More specific examples of the computer-readable storage medium may include, but are not limited to, an electrical connection having one or more wires, a portable computer diskette, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing. In the present disclosure, the computer-readable storage medium may be any tangible medium containing or storing a program that may be used by or in connection with an instruction execution system, apparatus, or device. In the present disclosure, a computer-readable signal medium may include a data signal propagated in baseband or as part of a carrier, where the computer-readable program code is carried. Such a propagated data signal may take a variety of forms including, but not limited to, an electromagnetic signal, an optical signal, or any suitable combination of the foregoing. The computer-readable signal medium may further be any computer-readable medium other than a computer-readable storage medium that may send, propagate, or transmit a program for use by or in connection with an instruction execution system, apparatus, or device. The program code contained in the computer-readable medium may be transmitted with any suitable medium, including, but not limited to: a wire, an optical cable, radio frequency (RF), and the like, or any suitable combination of the foregoing.

The computer-readable medium described above may be included in the electronic device; or may be separately present without being assembled into the electronic device.

The computer-readable medium carries one or more programs, and when the one or more programs are executed by the electronic device, the electronic device is enabled to perform the method shown in the foregoing embodiments.

Computer program code for performing the operations of the present disclosure may be written in one or more programming languages, including object-oriented programming languages, such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to a user computer through any kind of network, including a local area network (LAN) or a wide area network (WAN), or may be connected to an external computer (for example, using an Internet service provider for Internet connection).

The flowcharts and block diagrams in the figures illustrate architecture, functionality, and operation of possible implementations of systems, methods, and computer program products according to various embodiments of the present disclosure. In this regard, each block in the flowcharts or block diagrams may represent a module, program segment, or a portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in a reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. The name of the unit in some cases does not constitute a limitation on the unit itself, for example, the first obtaining unit may further be described as a “unit for obtaining at least two Internet Protocol addresses”.

The functions described above may be performed, at least in part, by one or more hardware logic components. For example, without limitation, example types of hardware logic components that may be used include: a field programmable gate array (FPGA), an application specific integrated circuit (ASIC), an application specific standard product (ASSP), a system-on-a-chip (SOC), a complex programmable logic device (CPLD), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium may include electrical connections based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

According to a first aspect, the method of displaying a video effect is provided according to one or more embodiments of the present disclosure, comprising:
obtaining a video, and extracting a user speech from the video;
generating, according to the user speech in the video, at least one first word corresponding to a content of the user speech; and
displaying, in the video, a texture corresponding to the at least one first word on a word-by-word basis, wherein the texture moves outwards along a trajectory and around a region in the video as a center.

According to one or more embodiments of the present disclosure, the video is a video comprising a user facial image, the region is a mouth region in the user facial image, and displaying, in the video, the texture corresponding to the first word on the word-by-word basis comprises: determining a facial orientation of a user according to the user facial image in the video; and controlling the texture to move along the facial orientation, starting from the mouth region.

According to one or more embodiments of the present disclosure, generating, according to the user speech in the video, the at least one first word corresponding to the content of the user speech comprises: performing speech recognition on the user speech to obtain a corresponding speech text, the speech text comprising at least one second word; and detecting the second word in the speech text, and in accordance with a determination that the second word is a predetermined first keyword, determining the second word as the first word.

According to one or more embodiments of the present disclosure, the method further comprises: in accordance with a determination that the first word is a predetermined second keyword, displaying, in the video, an environment effect corresponding to the second keyword, wherein the environment effect comprises a music effect and/or a texture effect corresponding to the second keyword; and the method further comprises before displaying, in the video, the environment effect corresponding to the second keyword: displaying, in the video, prompt information corresponding to the second keyword.

According to one or more embodiments of the present disclosure, displaying, in the video, the texture corresponding to the first word on the word-by-word basis comprises: obtaining a moving start point and a corresponding moving direction of the texture in the region; and after displaying the texture at the moving start point, controlling the texture to move based on the moving direction.

According to one or more embodiments of the present disclosure, obtaining the moving start point and the corresponding moving direction of the texture in the region comprises: randomly generating, in the region, the moving start point corresponding to the texture; and obtaining the moving direction according to a distance between the moving start point and an edge of the region, wherein the moving direction represents an angle between a moving path of the texture and a plane of the region, within a predetermined three-dimensional space of a camera.

According to one or more embodiments of the present disclosure, the region is an annular region, and randomly generating, in the region, the moving start point corresponding to the texture comprises: obtaining an inner radius length and an outer radius length corresponding to the region; randomly obtaining a radius based on the inner radius length and the outer radius length, a length of the radius being between the inner radius length and the outer radius length; and generating the moving start point according to the radius and a pre-generated angle.

According to one or more embodiments of the present disclosure, randomly obtaining the radius based on the inner radius length and the outer radius length comprises: obtaining, for the inner radius length and the outer radius length, respective squared inner radius length and squared outer radius length; obtaining a squared value range based on the squared inner radius length and the squared outer radius length, and randomly obtaining a squared radius value within the squared value range; and obtaining the radius according to a result of a square root operation on the squared radius value.

According to one or more embodiments of the present disclosure, obtaining the moving direction according to the distance between the moving start point and the edge of the region comprises: determining a corresponding deflection angle according to a first distance between the moving start point and the edge of the region, the deflection angle representing an angle at which a moving trajectory of the texture is deflected towards an edge of the video, and the deflection angle being proportional to the first distance; obtaining a space angle, the space angle being a three-dimensional space angle corresponding to a normal vector at the moving start point, in the plane of the region within the three-dimensional space of a camera; and determining the moving direction according to a vector sum of the space angle and the deflection angle.

According to one or more embodiments of the present disclosure, the method further comprises: setting, in controlling a movement of the texture, a word attribute corresponding to the texture, based on a moving distance of the texture; wherein the word attribute includes at least one of: font transparency, a font color, or a font size.

According to one or more embodiments of the present disclosure, controlling the texture to move comprises: obtaining a control parameter, the control parameter representing a condition for stopping displaying of the texture; controlling the texture to move based on the control parameter; wherein the control parameter includes a moving duration and/or a moving distance; the moving duration represents a duration of a movement of the texture; and the moving distance represents a continuous distance of the movement of the texture.

According to a second aspect, an apparatus for displaying a video effect is provided according to one or more embodiments of the present disclosure, comprising:
a speech module configured to obtain a video, and extract a user speech from the video;
a processing module configured to generate at least one first word corresponding to a content of the user speech according to the user speech in the video; and
a display module configured to display, in the video, a texture corresponding to the first word on a word-by-word basis, wherein the texture moves outwards along a trajectory and around a region in the video as a center.

In an embodiment of the present disclosure, the video is a video comprising a user facial image, the region is a mouth region in the user facial image, and the display module is configured to display, in the video, the texture corresponding to the first word on the word-by-word basis, which is specifically configured to determine a facial orientation of a user according to the user facial image in the video; and control the texture to move along the facial orientation, starting from the mouth region.

In an embodiment of the present disclosure, the processing module is configured to generate, according to the user speech in the video, the at least one first word corresponding to the content of the user speech, which is specifically configured to perform speech recognition on the user speech to obtain a corresponding speech text, the speech text comprising at least one second word; and detect the second word in the speech text, and in accordance with a determination that the second word is a predetermined first keyword, determining the second word as the first word.

In an embodiment of the present disclosure, the display module is further configured to, in accordance with a determination that the first word is a predetermined second keyword, display, in the video, a environment effect corresponding to the second keyword, where the environment effect comprises a music effect and/or a texture effect corresponding to the second keyword; and the display module is further configured to, before displaying, in the video, the environment effect corresponding to the second keyword, display, in the video, prompt information corresponding to the second keyword.

In an embodiment of the present disclosure, the display module is configured to display, in the video, the texture corresponding to the first word on the word-by-word basis, which is specifically configured to obtain a moving start point and a corresponding moving direction of the texture in the region; and after displaying the texture at the moving start point, control the texture to move based on the moving direction.

In an embodiment of the present disclosure, the display module is configured to obtain the moving start point and the corresponding moving direction of the texture in the region, which is specifically configured to randomly generate, in the region, the moving start point corresponding to the texture; and obtain the moving direction according to a distance between the moving start point and an edge of the region, where the moving direction represents an angle between a moving path of the texture and a plane of the region, within a predetermined three-dimensional space of a camera.

In an embodiment of the present disclosure, the region is an annular region, and the display module is configured to randomly generate, in the region, the moving start point corresponding to the texture, which is specifically configured to obtain an inner radius length and an outer radius length corresponding to the region; randomly obtain a radius based on the inner radius length and the outer radius length, a length of the radius being between the inner radius length and the outer radius length; and generate the moving start point according to the radius and a pre-generated angle.

In an embodiment of the present disclosure, the display module is configured to randomly obtain the radius based on the inner radius length and the outer radius length, which is specifically configured to obtain, for the inner radius length and the outer radius length, respective squared inner radius length and squared outer radius length; obtain a squared value range based on the squared inner radius length and the squared outer radius length, and randomly obtaining a squared radius value within the squared value range; and obtain the radius according to a result of a square root operation on the squared radius value.

In an embodiment of the present disclosure, the display module is configured to obtain the moving direction according to the distance between the moving start point and the edge of the region, which is specifically configured to determine a corresponding deflection angle according to a first distance between the moving start point and the edge of the region, the deflection angle representing an angle at which a moving trajectory of the texture is deflected towards an edge of the video, and the deflection angle being proportional to the first distance; obtain a space angle, the space angle being a three-dimensional space angle corresponding to a normal vector at the moving start point, in the plane of the region within the three-dimensional space of a camera; and determine the moving direction according to a vector sum of the space angle and the deflection angle.

In an embodiment of the present disclosure, the display module is further configured to set, in controlling a movement of the texture, a word attribute corresponding to the texture, based on a moving distance of the texture; wherein the word attribute includes at least one of: font transparency, a font color, or a font size.

In an embodiment of the present disclosure, the display module is configured to obtain a control parameter, the control parameter representing a condition for stopping displaying of the texture, which is specifically configure to control the texture to move based on the control parameter; wherein the control parameter includes a moving duration and/or a moving distance; the moving duration represents a duration of a movement of the texture; and the moving distance represents a continuous distance of the movement of the texture.

According to a third aspect, an electronic device is provided according to one or more embodiments of the present disclosure, comprising: a processor, and a memory communicatively connected to the processor;

the memory storing computer-executable instructions; the processor executing the computer-executable instructions stored in the memory, to implement the method of displaying a video effect according to the first aspect and various possible designs of the first aspect.

According to a fourth aspect, a computer-readable storage medium is provided according to one or more embodiments of the present disclosure, where the computer-readable storage medium stores computer-executable instructions, and when the processor executes the computer-executable instruction, and the computer-executable instructions, when executed by a processor, implement the method of displaying a video effect according to the first aspect and the possible designs of the first aspect.

According to a fifth aspect, an embodiment of the present disclosure provides a computer program product, comprising a computer program, and the computer program, when executed by a processor, implements the method of displaying a video effect according to the first aspect and various possible designs of the first aspect.

The above description is merely an illustration of the preferred embodiments of the present disclosure and the principles of the applied technology. It should be understood by those skilled in the art that the protection scope in the present disclosure is not limited to the technical solutions of the specific combination of the above technical features, and should also cover other technical solutions formed by any combination of the above technical features or their equivalent features without departing from the above disclosed concept, for example, technical solutions formed by substituting the aforementioned features with technical features that have similar functions to those disclosed (but not limited to) in the present disclosure.

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the present disclosure. Some features described in the context of separate embodiments may also be implemented in combination in a single embodiment. Conversely, the various features described in the context of a single embodiment may also be implemented in multiple embodiments individually or in any suitable sub-combination.

Although the present subject matter has been described in language specific to structural features and/or method logic acts, it is to be understood that the subject matter defined in the appended claims is not necessarily limited to the specific features or acts described above. Rather, the specific features and acts described above are merely example forms of implementing the claims.

1-20. (canceled)

21. A method of displaying a video effect, comprising:
obtaining a video, and extracting a user speech from the video;
generating, according to the user speech in the video, at least one first word corresponding to a content of the user speech; and
displaying, in the video, a texture corresponding to the at least one first word on a word-by-word basis, wherein the texture moves outwards along a trajectory and around a region in the video as a center.

22. The method of claim 21, wherein the video is a video comprising a user facial image, the region is a mouth region in the user facial image, and displaying, in the video, the texture corresponding to the first word on the word-by-word basis comprises:
determining a facial orientation of a user according to the user facial image in the video; and
controlling the texture to move along the facial orientation, starting from the mouth region.

23. The method of claim 21, wherein generating, according to the user speech in the video, the at least one first word corresponding to the content of the user speech comprises:
performing speech recognition on the user speech to obtain a corresponding speech text, the speech text comprising at least one second word; and
detecting the second word in the speech text, and in accordance with a determination that the second word is a predetermined first keyword, determining the second word as the first word.

24. The method of claim 21, further comprising:
in accordance with a determination that the first word is a predetermined second keyword, displaying, in the video, an environment effect corresponding to the second keyword, wherein the environment effect comprises a music effect and/or a texture effect corresponding to the second keyword; and
the method further comprises before displaying, in the video, the environment effect corresponding to the second keyword:
displaying, in the video, prompt information corresponding to the second keyword.

25. The method of claim 21, wherein displaying, in the video, the texture corresponding to the first word on the word-by-word basis comprises:
obtaining a moving start point and a corresponding moving direction of the texture in the region; and
after displaying the texture at the moving start point, controlling the texture to move based on the moving direction.

26. The method of claim 25, wherein obtaining the moving start point and the corresponding moving direction of the texture in the region comprises:
randomly generating, in the region, the moving start point corresponding to the texture; and
obtaining the moving direction according to a distance between the moving start point and an edge of the region, wherein the moving direction represents an angle between a moving path of the texture and a plane of the region, within a predetermined three-dimensional space of a camera.

27. The method of claim 26, wherein the region is an annular region, and randomly generating, in the region, the moving start point corresponding to the texture comprises:
obtaining an inner radius length and an outer radius length corresponding to the region;
randomly obtaining a radius based on the inner radius length and the outer radius length, a length of the radius being between the inner radius length and the outer radius length; and
generating the moving start point according to the radius and a pre-generated angle.

28. The method of claim 27, wherein randomly obtaining the radius based on the inner radius length and the outer radius length comprises:
obtaining, for the inner radius length and the outer radius length, respective squared inner radius length and squared outer radius length;
obtaining a squared value range based on the squared inner radius length and the squared outer radius length, and randomly obtaining a squared radius value within the squared value range; and
obtaining the radius according to a result of a square root operation on the squared radius value.

29. The method of claim 26, wherein obtaining the moving direction according to the distance between the moving start point and the edge of the region comprises:
determining a corresponding deflection angle according to a first distance between the moving start point and the edge of the region, the deflection angle representing an angle at which a moving trajectory of the texture is deflected towards an edge of the video, and the deflection angle being proportional to the first distance;
obtaining a space angle, the space angle being a three-dimensional space angle corresponding to a normal vector at the moving start point, in the plane of the region within the three-dimensional space of a camera; and
determining the moving direction according to a vector sum of the space angle and the deflection angle.

30. The method of claim 26, further comprising:
setting, in controlling a movement of the texture, a word attribute corresponding to the texture, based on a moving distance of the texture;
wherein the word attribute includes at least one of: font transparency, a font color, or a font size.

31. The method of claim 25, wherein controlling the texture to move comprises:
obtaining a control parameter, the control parameter representing a condition for stopping displaying of the texture;
controlling the texture to move based on the control parameter;
wherein the control parameter includes a moving duration and/or a moving distance; the moving duration represents a duration of a movement of the texture; and the moving distance represents a continuous distance of the movement of the texture.

32. An electronic device comprising:
a processor, and a memory communicatively connected to the processor;
the memory storing computer-executable instructions;
the processor executing the computer-executable instructions stored in the memory, causing the electronic device to perform acts, the acts comprising:
obtaining a video, and extracting a user speech from the video;
generating, according to the user speech in the video, at least one first word corresponding to a content of the user speech; and
displaying, in the video, a texture corresponding to the first word on a word-by-word basis, wherein the texture moves outwards along a trajectory and around a region in the video as a center.

33. The electronic device of claim 32, wherein the video is a video comprising a user facial image, the region is a mouth region in the user facial image, and
displaying, in the video, the texture corresponding to the first word on the word-by-word basis comprises:
determining a facial orientation of a user according to the user facial image in the video; and
controlling the texture to move along the facial orientation, starting from the mouth region.

34. The electronic device of claim 32, wherein generating, according to the user speech in the video, the at least one first word corresponding to the content of the user speech comprises:
performing speech recognition on the user speech to obtain a corresponding speech text, the speech text comprising at least one second word; and
detecting the second word in the speech text, and in accordance with a determination that the second word is a predetermined first keyword, determining the second word as the first word.

35. The electronic device of claim 32, the acts further comprising:
in accordance with a determination that the first word is a predetermined second keyword, displaying, in the video, a environment effect corresponding to the second keyword, wherein the environment effect comprises a music effect and/or a texture effect corresponding to the second keyword; and
the acts further comprising before displaying, in the video, the environment effect corresponding to the second keyword:
displaying, in the video, prompt information corresponding to the second keyword.

36. The electronic device of claim 32, wherein displaying, in the video, the texture corresponding to the first word on the word-by-word basis comprises:
obtaining a moving start point and a corresponding moving direction of the texture in the region; and
after displaying the texture at the moving start point, controlling the texture to move based on the moving direction.

37. The electronic device of claim 36, wherein obtaining the moving start point and the corresponding moving direction of the texture in the region comprises:
randomly generating, in the region, the moving start point corresponding to the texture; and
obtaining the moving direction according to a distance between the moving start point and an edge of the region, wherein the moving direction represents an angle between a moving path of the texture and a plane of the region, within a predetermined three-dimensional space of a camera.

38. The electronic device of claim 37, wherein the region is an annular region, and randomly generating, in the region, the moving start point corresponding to the texture comprises:
obtaining an inner radius length and an outer radius length corresponding to the region;
randomly obtaining a radius based on the inner radius length and the outer radius length, a length of the radius being between the inner radius length and the outer radius length; and
generating the moving start point according to the radius and a pre-generated angle.

39. The electronic device of claim 38, wherein randomly obtaining the radius based on the inner radius length and the outer radius length comprises:
obtaining, for the inner radius length and the outer radius length, respective squared inner radius length and squared outer radius length;
obtaining a squared value range based on the squared inner radius length and the squared outer radius length, and randomly obtaining a squared radius value within the squared value range; and
obtaining the radius according to a result of a square root operation on the squared radius value.

40. A non-transitory computer-readable storage medium, wherein the computer-readable storage medium stores computer-executable instructions, the computer-executable instructions, when executed by a processor, implementing acts, the acts comprising:
obtaining a video, and extracting a user speech from the video;
generating, according to the user speech in the video, at least one first word corresponding to a content of the user speech; and
displaying, in the video, a texture corresponding to the first word on a word-by-word basis, wherein the texture moves outwards along a trajectory and around a region in the video as a center.
